(19) United States
(12) Patent Application Publication
(10) Pub. No.: US 2015/0232648 A1
(43) Pub. Date: Aug. 20, 2015

(54) THREE-DIMENSIONAL PROTOTYPING COMPOSITION

(71) Applicant: MICROJET TECHNOLOGY CO., LTD., Hsinchu (TW)

(72) Inventors: Chieh-Yun Hsueh, Hsinchu (TW); Chi-Feng Huang, Hsinchu (TW); Yung-Lung Han, Hsinchu (TW)

(21) Appl. No.: 14/608,559

(22) Filed: Jan. 29, 2015

(30) Foreign Application Priority Data
Feb. 20, 2014 (TW) 103105641
Nov. 13, 2014 (TW) 103139327

(51) Int. Cl. C08L 3/02; C08L 3/00

(52) U.S. Cl. CPC C08L 3/02; C08L 3/00; B33Y 70/00

(57) ABSTRACT

A three-dimensional prototyping composition includes a construction powder mixture and an inkjet liquid. The construction powder mixture includes a powdery molding material and a powdery binding agent. The inkjet liquid includes a nonionic surfactant, at least one polyalcohol compound, an alcohol ether compound, an antimicrobial agent and deionized water. While the inkjet liquid and the construction powder mixture are in contact with each other, the physical binding function of the powdery binding agent of the construction powder mixture is activated. Consequently, the powdery molding material and the powdery binding agent stick together to form a molded construction layer of a three-dimensional object. Moreover, the construction powder mixture can be recycled. Moreover, since the inkjet liquid may be ejected through the thermal bubble printhead, the fabricating cost of the three-dimensional physical model is reduced.

### FIELD OF THE INVENTION

The present invention relates to a composition, and more particularly to a three-dimensional prototyping composition.

### BACKGROUND OF THE INVENTION

As known, a rapid prototyping (RP) technology is developed from the concepts of forming a pyramid by stacking layers, and the main technical feature is to achieve fast formation. A complicated design can be transformed into a three-dimensional physical model automatically and fast without any cutting tools, molds and fixtures. Thus, the development cycle of new products and research and development cost are largely reduced to ensure the time to market for new products and the first-time-right ratio. Accordingly, a complete and convenient product design tool is provided between technicians and non-technicians (e.g. managers and users), and the product competitiveness and the quick reaction capability of enterprises in the market are improved obviously.

Nowadays, the rapid prototyping technology is widely applied to the three-dimensional (3D) printing methods. For example, a binder jetting technology (also known as an inkjet powder printing technology) is one of the 3D printing methods. For example, by combining a precise inkjet printing technology and a precise carrier positioning technology, a three-dimensional physical model can be produced. The producing method begins by first spreading a layer of powder on the carrier and then printing high viscosity liquid binder on part of the powder by using the precise inkjet printing technology, so that the liquid binder and the powder stick together to become solidified. After the above steps are repeatedly done, a three-dimensional physical model is produced by stacking multiple layers.

Conventionally, for performing the binder jetting method, the constituents of the binder are adjusted according to the type of the construction powder to be used. Moreover, while the printing procedure is performed, the reaction between the binder and the binder or the reaction between the binder and the powder possibly takes place. Moreover, if the produced three-dimensional physical model is not satisfied, the produced three-dimensional physical model has to be discarded and cannot be recycled. Under this circumstance, the problem of wasting material occurs. On the other hand, for printing out different binders, the conventional inkjet powder printing method uses a piezoelectric printhead because the piezoelectric printheads are durable than the thermal bubble printhead. Consequently, the fabricating cost increases. In other words, the conventional binder jetting method is complicated and costly.

Therefore, there is a need of providing an improved three-dimensional prototyping composition in order to overcome the above drawbacks.

### SUMMARY OF THE INVENTION

An object of the present invention provides a three-dimensional prototyping composition. The three-dimensional prototyping composition comprises a construction powder mixture and an inkjet liquid. While the inkjet liquid and the construction powder mixture are in contact with each other, the physical binding function of the powdery binding agent of the construction powder mixture is activated. Consequently, the powdery molding material and the powdery binding agent stick together to form a molded construction layer of a three-dimensional object. Moreover, if the three-dimensional structure is not satisfied, the construction powder mixture can be recycled. Moreover, since it is not necessary to adjust the constituents of the binder according to the type of the construction powder to be used, the efficacy of using and recycling the material will be enhanced.

Another object of the present invention provides a three-dimensional prototyping composition. Since the three-dimensional prototyping composition may be ejected through the thermal bubble printhead, the fabricating cost of the three-dimensional physical model is reduced.

In accordance with an aspect of the present invention, there is provided a three-dimensional prototyping composition. The three-dimensional prototyping composition includes a construction powder mixture and an inkjet liquid. The construction powder mixture includes a powdery molding material and a powdery binding agent. The inkjet liquid includes a nonionic surfactant, at least one polyalcohol compound, an antimicrobial agent and deionized water.

In accordance with another aspect of the present invention, there is provided a three-dimensional prototyping composition. The three-dimensional prototyping composition includes a construction powder mixture and an inkjet liquid. The construction powder mixture includes a powdery molding material and a powdery binding agent. The inkjet liquid includes a nonionic surfactant, at least one polyalcohol compound, an alcohol ether compound, an antimicrobial agent and deionized water, wherein a content of the alcohol ether compound in the inkjet liquid is 0.01%˜5% by weight.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the particles of a construction powder mixture of a three-dimensional prototyping composition according to an embodiment of the present invention; and

FIG. 2 schematically illustrates a process of ejecting the print liquid to the construction powder mixture to produce a molded construction layer of a three-dimensional physical model.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

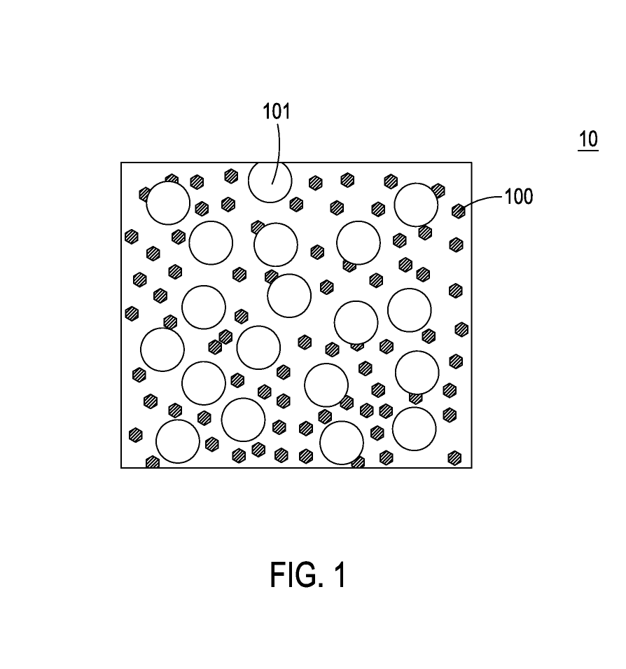

The present invention provides a three-dimensional prototyping composition. The three-dimensional prototyping composition comprises a construction powder mixture and an inkjet liquid. FIG. 1 schematically illustrates the particles of a construction powder mixture of a three-dimensional prototyping composition according to an embodiment of the present invention. The construction powder mixture 10 comprises a powdery molding material 100 and a powdery binding agent 101. The particles of the powdery molding material 100 and the powdery binding agent 101 are thoroughly mixed and uniformly distributed. Preferably, the content of the powdery binding agent 101 in the construction powder mixture 10 (i.e. the mixture of the powdery molding material 100 and the powdery binding agent 101) is 5%˜30% by volume. As the content of the powdery binding agent 101 in the construction powder mixture 10 increases, the structural strength of the produced three-dimensional physical model is enhanced. The powdery molding material 100 is made of a metallic material, a ceramic material (e.g. aluminum oxide) or a polymeric material. Moreover, the content of the powdery molding material 100 in the construction powder mixture 10 (i.e. the mixture of the powdery molding material 100 and the powdery binding agent 101) is less than 80% by weight.

The powdery binding agent 101 contains a main binder powder (not shown) and a high temperature binder powder (not shown). The main binder powder is selected from at least one of starch, dextrin, sugar and salt. The content of the main binder powder in the construction powder mixture 10 is less than 40% by weight. The high temperature binder powder is selected from kaolin or Windsor clay. The content of the high temperature binder powder in the construction powder mixture 10 is less than 30% by weight. The main binding capability of the binder powder at high temperature is inferior. If only the main binder powder is used and the construction powder mixture 10 is sintered at high temperature, the binding function provided by the powdery binding agent 101 is reduced and the structure of the powdery binding agent 101 is possibly destroyed. For solving this drawback, the powdery binding agent 101 further contains the high temperature binder powder. Consequently, when the construction powder mixture 10 is sintered at high temperature, the powdery binding agent 101 can normally provide the binding function so as to prevent the structural destruction.

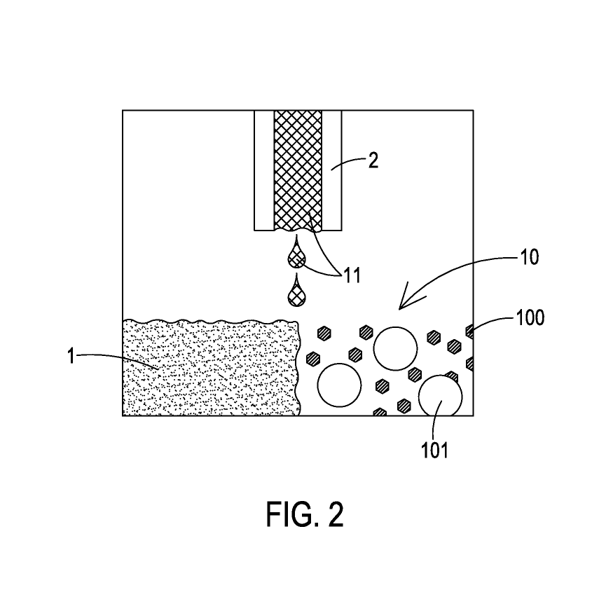

FIG. 2 schematically illustrates a process of ejecting the print liquid to the construction powder mixture to produce a molded construction layer of a three-dimensional physical model. As shown in FIGS. 1 and 2, after the construction powder mixture 10 is prepared, the construction powder mixture 10 is placed into a powder feeder (not shown) of a rapid prototyping apparatus (not shown). Then, the construction powder mixture 10 is pushed to a construction platform (not shown) of the rapid prototyping apparatus by a pushing element (not shown). Consequently, the procedure of feeding and spreading the construction powder mixture 10 is completed. Then, the inkjet liquid 11 is ejected from a thermal bubble printhead 2 to the construction powder mixture 10, which is spread on the construction platform. As locations of the thermal bubble printhead 2 are changed, the inkjet liquid 11 is ejected to desired locations of the construction powder mixture 10. While the inkjet liquid 11 and the construction powder mixture 10 are in contact with each other, the physical binding function of the powdery binding agent 101 of the construction powder mixture 10 is activated. Meanwhile, the powdery molding material 100 is wrapped by the powdery binding agent 101. Consequently, the powdery molding material 100 and the powdery binding agent 101 stick together to form a molded construction layer 1 of a three-dimensional object. The above steps are repeatedly done by using the construction powder mixture 10 as the construction material and using the inkjet liquid 11 to activate the physical binding function of the powdery binding agent 101. Consequently, a three-dimensional structure (not shown) is produced by stacking multiple molded construction layers. After the three-dimensional structure is treated by a high temperature sintering process at 1200˜1600° C., the three-dimensional structure is solidified. Consequently, a three-dimensional physical model is produced.

In an embodiment, the inkjet liquid 11 used in the present invention comprises a nonionic surfactant, at least one polyalcohol compound, an antimicrobial agent and deionized water.

The nonionic surfactant of the inkjet liquid 11 is an organic compound containing ethoxylated acetylenic diol. A suitable example of the nonionic surfactant includes but is not limited to Surynol® 440, Surynol® 465 or Surynol® 485 (Air Products and Chemicals, Inc.). The content of the nonionic surfactant in the inkjet liquid 11 is 0.5%˜2% by weight.

The polyalcohol compound of the inkjet liquid 11 is an alcohol compound containing two or more hydroxyl groups. A suitable example of the polyalcohol compound includes but is not limited to 1,2-propanediol, 1,3-propanediol, 1,2-butanediol, 1,3-butanediol, 1,4-butanediol, 1,2-pentanediol, 1,3-pentanediol, 1,4-pentanediol, 1,5-pentanediol, trimethylol ethane, trimethylol propane, glycerol, pentaerythritol or sorbitol. Preferably, the inkjet liquid 11 contains one, two or three kinds of polyalcohol compounds. The content of the at least one polyalcohol compound in the inkjet liquid 11 is 2%˜20% by weight.

The antimicrobial agent of the inkjet liquid 11 may be selected from any appropriate commercially-available antimicrobial agent. An example of the antimicrobial agent of the inkjet liquid 11 includes but is not limited to Proxel® GXL (Arch Chemicals, Inc.) or CANGUARD™ ULTRA BIT 20 DPG (Dow Chemical, Inc.). The content of the antimicrobial agent in the inkjet liquid 11 is 0.1%˜1% by weight.

The content of the deionized water in the inkjet liquid 11 is 80˜90% by weight. By properly adjusting the contents the nonionic surfactant, the at least one polyalcohol compound, the alcohol ether compound, the antimicrobial agent and the deionized water, the inkjet liquid 11 is obtained.

Alternatively, in some embodiments, the inkjet liquid 11 used in the present invention comprises a nonionic surfactant, at least one polyalcohol compound, an alcohol ether compound, an antimicrobial agent and deionized water.

The alcohol ether compound of the inkjet liquid 11 is a C₁˜C₄ linear alcohol ether compound. A suitable example of the alcohol ether compound includes but is not limited to diethylene glycol, triethylene glycol or tetraethylene glycol. The content of the alcohol ether compound in the inkjet liquid 11 is 0.01%˜5% by weight. Preferably, the total content of the at least one polyalcohol compound and the alcohol ether compound in the inkjet liquid 11 is less than 25% by weight.

Some representative formulations of the three-dimensional prototyping composition are listed in the following Table 1 and Table 2. In these formulations, Surynol® 485 is a nonionic surfactant obtained from Air Products and Chemicals, Inc., USA, and Proxel® GXL is an antimicrobial agent obtained from Arch Chemicals, Inc., USA. In Table 1 and Table 2, the contents of the powdery molding material 100 and the powdery binding agent 101 are weight percentages with respect to the construction powder mixture 10, and the contents of the nonionic surfactant, the polyalcohol compound, the alcohol ether compound, the antimicrobial agent and the deionized water are weight percentages with respect to the inkjet liquid 11.

TABLE 1
Representative formulations of the three-dimensional prototyping
compositions of Examples 1, 2 and 3

| | | | Example 1 | Example 2 | Example 3 |
|---|---|---|---|---|---|
| Constituents | | | (wt %) | | |
| Construction | Powdery molding | Ceramic powder | 62 | 62 | 62 |
| powder | material | | | | |
| mixture | Main binder powder | Starch | 20 | 20 | 20 |
| | High temperature | Windsor clay | 18 | 18 | 18 |
| | binder powder | | | | |
| Inkjet liquid | Nonionic surfactant | Surynol 485 | 0.7 | 0.7 | 0.7 |
| | Polyalcohol | 1,5-pentanediol | 2 | 5 | 5 |
| | | Glycerol | 8 | 10 | 10 |
| | Alcohol ether | Diethylene | 0 | 2 | 5 |
| | | glycol | | | |
| | Antimicrobial agent | Proxel GXL | 0.1 | 0.1 | 0.1 |

| | | | |
|---|---|---|---|
| Deionized water | 89.2 | 82.2 | 79.2 |

TABLE 2
Representative formulations of the three-dimensional prototyping
compositions of Examples 4, 5 and 6

| | | | Example 4 | Example 5 | Example 6 |
|---|---|---|---|---|---|
| Constituents | | | (wt %) | | |
| Construction | Powdery molding | Silicon oxide | 62 | 62 | 62 |
| powder | material | powder | | | |
| mixture | Main binder powder | Dextrin | 20 | 20 | 20 |
| | High temperature | Kaolin | 18 | 18 | 18 |
| | binder powder | | | | |
| Inkjet liquid | Nonionic surfactant | Surynol 485 | 0.7 | 0.7 | 0.7 |
| | Polyalcohol | 1,5-pentanediol | 2 | 5 | 5 |
| | | Glycerol | 8 | 10 | 10 |
| | Alcohol ether | Diethylene | 0 | 2 | 5 |
| | | glycol | | | |
| | Antimicrobial agent | Proxel GXL | 0.1 | 0.1 | 0.1 |

| | | | |
|---|---|---|---|
| Deionized water | 89.2 | 82.2 | 79.2 |

As shown in Table 1 and Table 2, the three-dimensional prototyping composition comprises a construction powder mixture and an inkjet liquid. The content of the powdery molding material in the construction powder mixture is less than 80% by weight. The content of the main binder powder in the construction powder mixture is less than 40% by weight, and the content of the high temperature binder powder in the construction powder mixture is less than 30% by weight. The content of the nonionic surfactant in the inkjet liquid is 0.5˜2% by weight. The content of the at least one polyalcohol compound in the inkjet liquid is 2%˜20% by weight. The content of the alcohol ether compound in the inkjet liquid is 0%˜5% by weight. The content of the antimicrobial agent in the inkjet liquid is 0.1%˜1% by weight. The content of the deionized water in the inkjet liquid is 80%˜90% by weight. The ranges of these contents are feasible with the support of the data listed in the above two tables.

As previously described, for performing the conventional binder jetting method, the constituents of the binder are adjusted according to the type of the construction powder to be used. Moreover, since the conventional binder is readily subjected to a reaction at high temperature, it is necessary to use the piezoelectric printhead. By properly adjusting the contents the nonionic surfactant, the at least one polyalcohol compound, the alcohol ether compound, the antimicrobial agent and the deionized water, the inkjet liquid of the present invention is obtained. Since the inkjet liquid of the present invention can withstand high temperature, the inkjet liquid may be ejected through the thermal bubble printhead. Under this circumstance, the fabricating cost of the three-dimensional physical model is reduced. On the other hand, while the inkjet liquid and the construction powder mixture are in contact with each other, the physical binding function of the powdery binding agent of the construction powder mixture is activated. Consequently, the powdery molding material and the powdery binding agent stick together to form a molded construction layer of a three-dimensional object. By stacking multiple molded construction layers, a three-dimensional structure is produced. If the three-dimensional structure is not satisfied, the user may crush the three-dimensional structure and grind the three-dimensional structure into power particles. After the inkjet liquid contained in the power particles is vaporized, the construction powder mixture can be recycled. Consequently, the problem of wasting material is solved.

From the above descriptions, the present invention provides a three-dimensional prototyping composition. The three-dimensional prototyping composition comprises a construction powder mixture and an inkjet liquid. While the inkjet liquid and the construction powder mixture are in contact with each other, the physical binding function of the powdery binding agent of the construction powder mixture is activated. Consequently, the powdery molding material and the powdery binding agent stick together to form a molded construction layer of a three-dimensional object. Moreover, if the three-dimensional structure is not satisfied, the construction powder mixture can be recycled. Moreover, since it is not necessary to adjust the constituents of the binder according to the type of the construction powder to be used, the efficacy of using and recycling the material will be enhanced. Moreover, since the inkjet liquid may be ejected through the thermal bubble printhead, the fabricating cost of the three-dimensional physical model is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A three-dimensional prototyping composition, comprising:
a construction powder mixture comprising a powdery molding material and a powdery binding agent; and
an inkjet liquid comprising a nonionic surfactant, at least one polyalcohol compound, an antimicrobial agent and deionized water.

2. The three-dimensional prototyping composition according to claim 1, wherein a content of the powdery binding agent in the construction powder mixture is 5%˜30% by volume.

3. The three-dimensional prototyping composition according to claim 1, wherein a content of the powdery molding material in the construction powder mixture is less than 80% by weight.

4. The three-dimensional prototyping composition according to claim 1, wherein the powdery binding agent contains a main binder powder and a high temperature binder powder, wherein a content of the main binder powder in the construction powder mixture is less than 40% by weight, and a content of the high temperature binder powder in the construction powder mixture is less than 30% by weight.

5. The three-dimensional prototyping composition according to claim 1, wherein the nonionic surfactant is an organic compound containing ethoxylated acetylenic diol, wherein a content of the nonionic surfactant in the inkjet liquid is 0.5%˜2% by weight.

6. The three-dimensional prototyping composition according to claim 1, wherein the polyalcohol compound is 1,2-propanediol, 1,3-propanediol, 1,2-butanediol, 1,3-butanediol, 1,4-butanediol, 1,2-pentanediol, 1,3-pentanediol, 1,4-pentanediol, 1,5-pentanediol, trimethylol ethane, trimethylol propane, glycerol, pentaerythritol or sorbitol.

7. The three-dimensional prototyping composition according to claim 1, wherein a content of the at least one polyalcohol compound in the inkjet liquid is 2%˜20% by weight.

8. The three-dimensional prototyping composition according to claim 1, wherein the inkjet liquid further comprises an alcohol ether compound.

9. The three-dimensional prototyping composition according to claim 8, wherein a content of the alcohol ether compound in the inkjet liquid is 0.01%˜5% by weight.

10. The three-dimensional prototyping composition according to claim 9, wherein a total content of the at least one polyalcohol compound and the alcohol ether compound in the inkjet liquid is less than 25% by weight.

11. The three-dimensional prototyping composition according to claim 8, wherein the alcohol ether compound is a C₁˜C₄ linear alcohol ether compound selected from diethylene glycol, triethylene glycol or tetraethylene glycol.

12. The three-dimensional prototyping composition according to claim 1, wherein a content of the antimicrobial agent in the inkjet liquid is 0.1˜1% by weight.

13. The three-dimensional prototyping composition according to claim 1, wherein a content of the deionized water in the inkjet liquid is 80%˜90% by weight.

14. The method according to claim 1, wherein the inkjet liquid is ejected to the spread construction powder mixture through a thermal bubble printhead or a piezoelectric printhead.

15. A three-dimensional prototyping composition, comprising:
a construction powder mixture comprising a powdery molding material and a powdery binding agent; and
an inkjet liquid comprising a nonionic surfactant, at least one polyalcohol compound, an alcohol ether compound, an antimicrobial agent and deionized water, wherein a content of the alcohol ether compound in the inkjet liquid is 0.01%˜5% by weight.

16. The three-dimensional prototyping composition according to claim 15, wherein the nonionic surfactant is an organic compound containing ethoxylated acetylenic diol, wherein a content of the nonionic surfactant in the inkjet liquid is 0.5%˜2% by weight.

17. The three-dimensional prototyping composition according to claim 15, wherein the polyalcohol compound is 1,2-propanediol, 1,3-propanediol, 1,2-butanediol, 1,3-butanediol, 1,4-butanediol, 1,2-pentanediol, 1,3-pentanediol, 1,4-pentanediol, 1,5-pentanediol, trimethylol ethane, trimethylol propane, glycerol, pentaerythritol or sorbitol, and wherein a content of the polyalcohol compound in the inkjet liquid is 2%˜20% by weight.

18. The three-dimensional prototyping composition according to claim 15, wherein a total content of the at least one polyalcohol compound and the alcohol ether compound in the inkjet liquid is less than 25% by weight, and wherein the alcohol ether compound is a C₁˜C₄ linear alcohol ether compound selected from diethylene glycol, triethylene glycol or tetraethylene glycol.

19. The three-dimensional prototyping composition according to claim 15, wherein a content of the antimicrobial agent in the inkjet liquid is 0.1˜1% by weight.

20. The three-dimensional prototyping composition according to claim 15, wherein a content of the deionized water in the inkjet liquid is 80%˜90% by weight.
